(19) United States
(12) Patent Application Publication
(10) Pub. No.: US 2026/0112104 A1
(43) Pub. Date: Apr. 23, 2026

(54) PHOTOREALISTIC CONTENT GENERATION FROM ANIMATED CONTENT BY NEURAL RADIANCE FIELD DIFFUSION GUIDED BY VISION-LANGUAGE MODELS

(71) Applicant: Huawei Technologies Co., Ltd., Shenzhen (CN)

(72) Inventors: Wei Jiang, Sunnyvale, CA (US); Wei Wang, San Jose, CA (US); Yue Chen, Saratoga, CA (US)

(21) Appl. No.: 19/423,514

(22) Filed: Dec. 17, 2025

Related U.S. Application Data
(63) Continuation of application No. PCT/US2024/031471, filed on May 29, 2024.
(60) Provisional application No. 63/508,997, filed on Jun. 19, 2023.

(51) Int. Cl. G06T 15/20; G06T 13/40

(52) U.S. Cl. CPC G06T 15/205; G06T 13/40

(57) ABSTRACT

A method implemented by a computing device. The method includes obtaining one or more of animated video content (X), a text prompt (Y), and view information (V); generating photorealistic two dimensional (2D) image frames (\hat{X}) based on the animated video content, the text prompt, and the view information using a vision-language model; and rendering photorealistic three dimensional (3D) image frames (X̅) based on the photorealistic 2D image frames using a 3D representation model.

### CROSS-REFERENCE TO RELATED APPLICATIONS

This is a continuation of International Patent Application PCT/US2024/031471 filed May 29, 2024, which claims the benefit of U.S. Provisional Patent Application No. 63/508,997 filed Jun. 19, 2023, which are hereby incorporated by reference in their entireties.

### TECHNICAL FIELD

The present disclosure describes techniques for generating video content. More specifically, this disclosure describes techniques for generating photorealistic three dimensional (3D) video content from animated two dimensional (2D) or 3D video content.

### BACKGROUND

Photorealism is a genre of art that encompasses painting, drawing, and other graphic media in which an artist studies a photograph and then attempts to reproduce the image as realistically as possible in another medium. For example, photorealism techniques produce images and animations that look exactly like photographs.

Photorealistic 3D video content techniques are often used in advertising and marketing to demonstrate how a product will look when the product is finished. While there are many different techniques for achieving photorealism, 3D design renderings generally involve a lot of manual labor and time.

### SUMMARY

The disclosed embodiments provide techniques for generating photorealistic 3D video content from animated 2D or 3D video content using neural radiance fields (NeRF) diffusion which is guided by vision-language models. In an embodiment, a framework that uses vision-language models to compute photorealistic 2D image frames through text-guided animated-to-photorealistic image transformation is utilized. The photorealistic 2D image frames are used to train (a.k.a., learn) a three dimensional (3D) representation model (e.g., a NeRF diffusion model). Once trained, the 3D representation model is able to represent photorealistic 3D video content and to generate novel photorealistic 3D image frames from novel view angles.

A first aspect relates to a method implemented by a computing device, comprising: obtaining one or more of animated video content (X), a text prompt (Y), and view information (V); generating photorealistic two dimensional (2D) image frames (\hat{X}) based on the animated video content, the text prompt, and the view information using a vision-language model; rendering photorealistic three dimensional (3D) image frames (X̅) based on the photorealistic 2D image frames using a 3D representation model; obtaining a novel view (v*); and generating a novel image (x̅*) for a 3D scene based on the novel view using the photorealistic 2D image frames.

Optionally, in any of the preceding aspects, another implementation of the aspect provides that the obtaining the one or more of the animated video content, the text prompt, and the view information, the generating photorealistic 2D image frames, and the rendering photorealistic 3D image frames (X̅) is iterated a number of times (t) to train the 3D representation model.

Optionally, in any of the preceding aspects, another implementation of the aspect provides that the 3D image frames comprise 2D image frames and the view information associated with the 2D image frames.

Optionally, in any of the preceding aspects, another implementation of the aspect provides that the text prompt specifies how an animated image is to be edited to generate one of the photorealistic 3D image frames.

Optionally, in any of the preceding aspects, another implementation of the aspect provides obtaining side information, and computing the photorealistic 2D image frames based on the side information.

Optionally, in any of the preceding aspects, another implementation of the aspect provides that the 3D representation model comprises a neural radiance fields (NeRF) diffusion model or a 3D-aware NeRF diffusion model.

Optionally, in any of the preceding aspects, another implementation of the aspect provides that the animated content comprises a set of animated images represented as images x₁, . . . xₙ, wherein the view information is represented as views v₁, . . . vₙ, wherein n is greater than or equal to 1, and wherein each view vᵢ provides view-related information for each image xᵢ.

Optionally, in any of the preceding aspects, another implementation of the aspect provides that the view-related information comprises one or more of a view angle and a camera intrinsic parameter.

Optionally, in any of the preceding aspects, another implementation of the aspect provides that an image xᵢ is associated with a depth map.

Optionally, in any of the preceding aspects, another implementation of the aspect provides sequentially displaying the photorealistic 3D image frames on a display to produce 3D video content.

Optionally, in any of the preceding aspects, another implementation of the aspect provides that generation of the 2D image frames comprises computing one or more of the following: an image encoding feature (F_{X}) based on the animated video content; a text encoding feature (F_{Y}) based on the text prompt; a view encoding feature (F_{V}) based on the view information; and a render image encoding feature (F_{X̅}) based on one of the photorealistic 3D image frames.

Optionally, in any of the preceding aspects, another implementation of the aspect provides that generation of the 2D image frames comprises computing a side information feature (F_{S}).

Optionally, in any of the preceding aspects, another implementation of the aspect provides generating the photorealistic 2D image frames based on one or more of the image encoding feature, the text encoding feature, the view encoding feature, the render encoding feature, and the side information feature.

Optionally, in any of the preceding aspects, another implementation of the aspect provides that the vision-language model comprises a multi-modal conditioned reverse diffusion module, wherein the multi-modal conditioned reverse diffusion module comprises a conditioning module that computes a diffusion condition (C) based on one or more of the image encoding feature, the view encoding feature, and the text encoding feature, wherein the multi-modal conditioned reverse diffusion module comprises a reverse prediction module that computes a reverse diffusion step p_{ϑ}(F_{\hat{X}}_{ₖ₋₁}|F_{\hat{X}}_{ₖ}, C), where ϑ represents model parameters of the reverse prediction module, k represents a number of iterations, and C represents the diffusion condition, and wherein the multi-modal conditioned reverse diffusion module comprises a decoding network that computes one or more of the photorealistic 3D image frames based on the reversion diffusion step.

Optionally, in any of the preceding aspects, another implementation of the aspect provides that the 3D representation model is trained in a first stage when: a neural radiance fields (NeRF)-based model computes the photorealistic 3D image frames; a photorealistic image generation module computes the photorealistic 2D image frames based on the one or more of the photorealistic 3D image frames, the text prompt, the view information, and the animated video content; a first stage compute loss module computes a first stage compute loss based on the photorealistic 3D image frames and the photorealistic 2D image frames; and a first stage backpropagation and update module computes a first stage gradient of the photorealistic 3D image frames and the photorealistic 2D image frames based on the first stage compute loss and backpropagates the first stage gradient to update model parameters of the NeRF-based model.

Optionally, in any of the preceding aspects, another implementation of the aspect provides that the 3D representation model is trained in a second stage when: the NeRF-based model computes the photorealistic 3D image frames, wherein each of the photorealistic 3D image frames corresponds to each view; a high-quality (HQ) appearance diffusion module uses a text-to-image diffusion network to compute HQ photorealistic 3D image frames based on the photorealistic 3D image frames and the text prompt; a second stage compute loss module computes a second stage compute loss based on the HQ photorealistic 3D image frames and the photorealistic 3D image frames; and a second stage backpropagation and update module computes a second stage gradient of the photorealistic 3D image frames and the HQ photorealistic 3D image frames based on the second stage compute loss and backpropagates the second stage gradient to update model parameters of the NeRF-based model.

Optionally, in any of the preceding aspects, another implementation of the aspect provides that one or more of the photorealistic image generation module, first stage compute loss module, and first stage backpropagation and update module receive and use side information.

Optionally, in any of the preceding aspects, another implementation of the aspect provides finally testing the 3D representation model by: computing an initial rendered image (\hat{x}ᵢₙᵢₜ*) based on the novel view (v*) using the NeRF-based model; and computing a final rendered 3D image frame (X̅*) based on the initial rendered image using the HQ appearance diffusion module.

A second aspect relates to a computing device, comprising: a memory storing instructions; and one or more processors coupled to the memory, the one or more processors configured to execute the instructions to cause the computing device to: obtain one or more of animated video content (X), a text prompt (Y), and view information (V); generate photorealistic two dimensional (2D) image frames (\hat{X}) based on the animated video content, the text prompt, and the view information using a vision-language model; render photorealistic three dimensional (3D) image frames (X̅) based on the photorealistic 2D image frames using a 3D representation model; obtain a novel view (v*); and generate a novel image (x̅*) for a 3D scene based on the novel view using the photorealistic 2D image frames.

A third aspect relates to a non-transitory computer readable medium comprising a computer program product for use by a computing device, the computer program product comprising computer executable instructions stored on the non-transitory computer readable medium that, when executed by one or more processors, cause the ingress network node to: obtain one or more of animated video content (X), a text prompt (Y), and view information (V); generate photorealistic two dimensional (2D) image frames (\hat{X}) based on the animated video content, the text prompt, and the view information using a vision-language model; render photorealistic three dimensional (3D) image frames (X̅) based on the photorealistic 2D image frames using a 3D representation model; obtain a novel view (v*); and generate a novel image (x̅*) for a 3D scene based on the novel view using the photorealistic 2D image frames.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a general framework for artificial intelligence generated content (AIGC).

FIG. 2 is a schematic diagram of a general overall workflow of neural radiance fields (NeRF).

FIG. 3 is a schematic diagram of an overall workflow for photorealistic content generation from animated content by NeRF diffusion guided by vision-language models according to an embodiment of the disclosure.

FIG. 4 is a schematic diagram of a photorealistic image generation module according to an embodiment of the disclosure.

FIG. 5 is a schematic diagram of a multi-modal conditional reverse diffusion module according to an embodiment of the disclosure.

FIG. 6 is a schematic diagram of a first stage of a training process of a 3D representation model according to an embodiment of the disclosure.

FIG. 7 is a schematic diagram of a second stage of a training process of the 3D representation model according to an embodiment of the disclosure.

FIG. 8 is a schematic diagram of a final test stage of the 3D representation model according to an embodiment of the disclosure.

FIG. 9 is a method implemented by a computing device according to an embodiment of the disclosure.

FIG. 10 is a schematic diagram of a network apparatus according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Great success has been achieved for AI generated content (AIGC) by using a wide range of image generative models, including generative adversarial networks (GAN) as detailed in document [1] (see list of documents, below), diffusion models as detailed in document [2], and auto-regressive (AR) models as detailed in document [3]. The goal is to enable fast and accessible high-quality content creation. Various methods have been developed to allow for efficient manipulation of the generated content using different types of inputs, such as using text descriptions as detailed in document [4] and/or spatial/spatiotemporal compositions like sketches or segmentations as detailed in document [5].

Large-scale pretrained vision-language models (VLM) have reached a milestone in text-to-image generation for AIGC. By training a very large model using very large datasets of captioned images from the internet, a multi-modal language-image pre-training representation like contrastive language-image pre-training (CLIP) as detailed in document [6] or bootstrapping language-image pre-training (BLIP) as detailed in document [7] can be successfully learned through self-supervised contrastive learning. The joint embedding space of text and image is robust to image distribution shift, which enables language-guided zero-shot image generation.

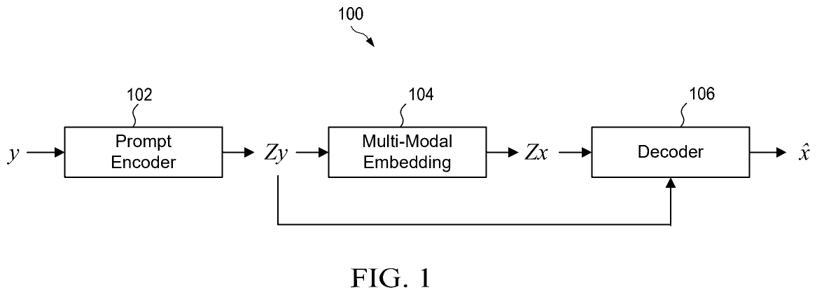

FIG. 1 is a schematic diagram of a general framework 100 for artificial intelligence generated content (AIGC). The general framework 100 is represented as a general processing pipeline. To begin, a prompt input y is input into and passed through a prompt encoder 102. The prompt encoder 102 generates a prompt embedding feature z_{y} based on the prompt input y. The prompt embedding feature z_{y} is used to compute an image embedding feature zₓ. In an embodiment, the prompt embedding feature z_{y} uses a multi-modal embedding network 104 to model the conditional probability P(z_{y}|zₓ). Then, a decoding network 106 (a.k.a., decoder) computes an output image \hat{x} based on the image embedding feature zₓ and the prompt embedding feature z_{y}. The target is to achieve high visual perceptual quality (e.g., natural and photorealistic, low level of visible artifacts, etc.) of the generated output image \hat{x}, and the semantic alignment of the output image \hat{x} to the requirement described by the prompt input y.

### Text-to-3D Generation.

Automatic 3D content creation from large language models (LLM) has been actively studied recently. Compared to the text-to-image generation depicted in FIG. 1, the performance of 3D content generation is quite limited due to the lack of diverse large-scale 3D datasets available for training effective models. Most existing works as detailed in documents [8,11,12] mitigate the training data issue by relying on a pre-trained vision-language model like CLIP as detailed in document [6] or Imagen as detailed in document [9] to optimize the underlying 3D representations like neural radiance fields (NeRF) as detailed in document [10]. However, the rendered results are usually limited to object categories or simple scenes composed by limited object categories with low-fidelity and resolution. It is non-trivial to extend such methods to generate arbitrary photorealistic 3D scenes with high fidelity and high resolution from only text guidance.

### Text-Guided Image-to-Image Transformation.

Image-to-image transformation has been largely used for transferring image styles. The recent works use pretrained text-to-image diffusion models like Imagen as detailed in document [9] to create variations of images, to in-paint image regions, to manipulate specific image regions, or to generate photorealistic images from animated ones. Comparing with text-to-image generation, text-guided image-to-image transformation gives better control over the generated image content, since it is innately difficult to use text description to accurately describe every detailed aspect of the image content, such as the size, shape, color, and location of various objects, the scene composition, etc.

### NeRF.

Neural radiance fields (NeRF) as detailed in document [10] are an approach towards inverse rendering where a volumetric ray tracer is combined with a neural mapping from spatial coordinates to color and volumetric density. Specifically, rendering an image from a NeRF is done by casting a ray for each pixel from a camera's center of projection through the pixel's location in the image plane and out into the world. The neural mapping function φ(μ, ν) takes as input the 3D position of a sampled 3D point along each ray and the camera view angle of the image to render, and outputs the volumetric density τ and red green blue (RGB) color c. The densities and colors of many sampled 3D points are fed into the volumetric ray tracer to render the output image.

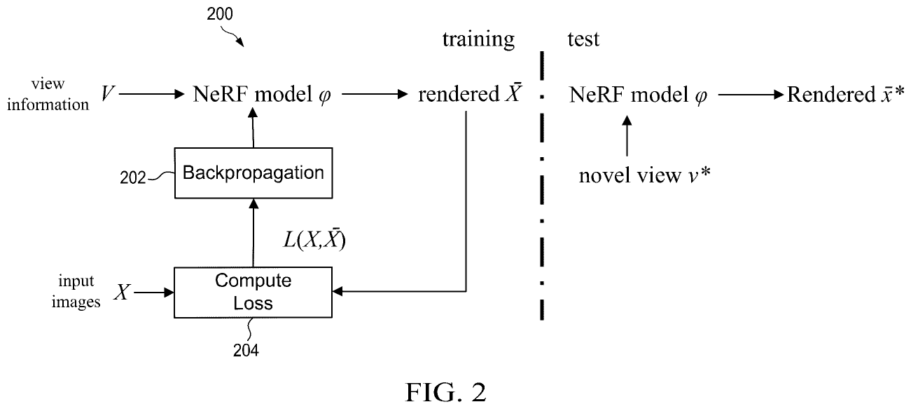

FIG. 2 is a schematic diagram of a general overall workflow 200 (a.k.a., framework) of NeRF. For a given 3D scene, many images X of that scene as well as the corresponding view information V (e.g., camera view angles) is provided as input to learn the neural mapping function of the NeRF model φ, by computing a loss function L (X, X̅) between the rendered images X and the input images X (e.g., Mean Square Error (MSE) as MSE loss) through a compute loss 202 process and then backpropagating the gradient of the loss function to update the model weights through a backpropagation 204 process. Then, in the test stage, given a novel camera view angle v*, the learned NeRF model φ can render the novel image x̅* of the scene for that camera view angle.

### Problems.

3D digital content has been in high demand for a large variety of applications like gaming and entertainment. Unfortunately, conventional 3D content generation requires professional artistic and 3D modelling expertise, and the costly label-intensive process has been a major issue limiting the quantity and accessibility of 3D content. Automatic 3D content creation powered by VLM has drawn significant attention because VLM gives the potential to democratize 3D digital content creation for novices and normal users.

However, existing text-to-3D content creation methods have the following problems or drawbacks. First, controlling the generated visual content based on mainly text descriptions is difficult because accurately describing every detailed aspect of the image content using languages is challenging. Second, using implicit 3D scene representations as detailed in documents [8,11] or using an estimated intermediate 3D scene representation as proxy as detailed in document [12] is suboptimal to recover finer geometries and achieve photorealistic rendering. The resulting resolution and realistic quality of the rendered results are limited to object categories or simple scenes composed by limited object categories.

Disclosed herein are techniques for generating photorealistic 3D video content from animated 2D or 3D video content using NeRF diffusion which is guided by vision-language models. In an embodiment, a framework that uses vision-language models to compute photorealistic 2D image frames through text-guided animated-to-photorealistic image transformation is utilized. The photorealistic 2D image frames are used to train (a.k.a., learn) a three dimensional (3D) representation model (e.g., a NeRF diffusion model). Once trained, the 3D representation model is able to represent photorealistic 3D video content and to generate novel photorealistic 3D image frames from novel view angles.

The disclosed techniques offer a novel framework enabling the new functionality of generating photorealistic 3D video from animated synthetic 3D video, providing the new feature to create novel photorealistic high-quality free-view 3D video content, while controlling the content semantics. The disclosed techniques offer tangible benefits relative to existing techniques including. For example, compared to previous AIGC-based video generation, the disclosed techniques allow strong control of the generated content by synthetic video. In addition, compared to previous NeRF-based photorealistic free-view 3D video generation, the disclosed techniques allows novel content which is not limited to any specific captured real-world scene to be created.

As a practical application, the disclosed techniques improve the quality (e.g., resolution, fidelity, naturalness, etc.) of the generated 3D video, especially for arbitrary video content. When the quality is improved, the overall experience of the user consuming the generated 3D video is enhanced. For example, video content consumed by individuals playing games or viewing media on a computing device is improved relative to the video content generated using existing techniques. The disclosed techniques also improve computer technology by beneficially changing the way a computing device renders video content. That is, the disclosed techniques improve an existing technological process for generating and displaying video content to the user of a computing device. Moreover, the disclosed techniques solve a technological problem. For example, video content that might have otherwise been blurry, unrealistic, or unappealing to a user of the computer due to drawbacks with existing techniques is instead crisp and clear using the disclosed techniques.

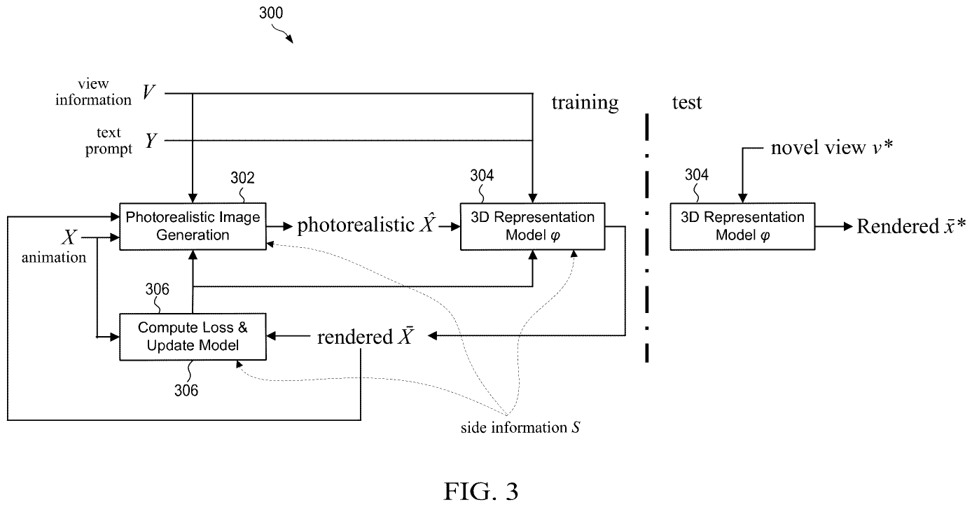

FIG. 3 is a schematic diagram of an overall workflow 300 (a.k.a., framework) for photorealistic content generation from animated content by NeRF diffusion guided by vision-language models according to an embodiment of the disclosure. In an embodiment, the overall workflow 300 is implemented by or on a personal computer (PC), a smart phone, a smart tablet, or some other computing device used to play games or consume entertainment.

As will be more fully explained below, the overall workflow 300 is configured to generate photorealistic 3D video content from animated 2D or 3D video content based on robust, text-guided animated-to-photorealistic image-to-image transformation and 3D-aware NeRF representation. Instead of relying on text descriptions for text-to-3D content generation, the animated 2D or 3D frames provide rich visual details and provide much better control over the generated result through image-to-image transformation. Instead of using only implicit NeRF-based 3D scene representation, the proposed framework uses explicit 3D information from the animated content to render photorealistic rendering with fine geometry details. The proposed method is able to mitigate the problems of existing text-to-3D content creation and can be applied to arbitrary content with arbitrary objects and complex scene composition.

As shown in FIG. 3, the overall framework 300 (a.k.a., system) is given an input animation X comprising a set of animated images x₁, . . . , xₙ, n≥1, a text prompt Y that provides text guidance to the generation, and a view information V comprising v₁, . . . , vₙ, n≥1, where each vᵢ gives the view-related information for each xᵢ, such as the view angle, the camera intrinsic parameters, etc. In an embodiment, the input animation X comprises one or more synthetic frames, fixed camera views of poor quality, or controlled content.

Each image xᵢ can be a 2D image with 1-channel (gray scale) or 3-channel RGB color. Each image xᵢ can also be associated with a depth map, i.e., xᵢ is a 3D image. The system is also given a text prompt Y as input. In general, text prompt Y provides language guidance for the generated result. For example, same as existing text-to-3D generation methods as detailed in documents [8,11,12], text prompt Y can describe the object and composition of the generated scene, like “a dog next to a cat.” Because of the visual informative input animation X, the text prompt Y can be more flexible to directly describe more details about the final generated results instead of simple object categories or scene compositions, which has been captured mostly by the input animation X. For example, the text prompt Y can be “real husky dog and real British shorthair cat in underwater coral reef scene.” That is, the text prompt Y provides the information about which part of the animation input X should be rendered as photorealistic, and the desired editing (changes) made to the original animation input X by the final generated results. Note that the text prompt Y can be optionally preset as a general guideline, such as “high resolution natural image.”

During the training process, a total of T iterations are taken. During each iteration t, based on the input animation X, the text prompt Y, the view information V, and a rendered X̅ from the previous iteration (can be randomly initialized as noise for the first iteration t=1), a photorealistic image generation module 302 computes a photorealistic image set \hat{X} comprising of a set of photorealistic images \hat{x}₁, . . . , \hat{x}ₙ, n≥1. In an embodiment, the photorealistic image set \hat{X} includes photorealistic frames, novel content, the same camera views relative to the input, and/or the same semantic content relative to the input.

In an embodiment, the photorealistic image generation module 302 performs an AIGC-based synthetic to photorealistic transformation. As used herein, the term module may refer to hardware, software, firmware, or some combination thereof.

Each photorealistic image \hat{x}ᵢ corresponds to an animated input xᵢ. Then, a 3D representation model ψ 304 computes the rendered image set X̅ for the current iteration t comprising of a set of rendered images x̅₁, . . . , x̅ₙ, n≥1, based on the photorealistic image set X̅, the view information V, and the text prompt Y. In an embodiment, the 3D representation model ψ 304 comprises a NeRF model.

Each rendered image x̅ᵢ corresponds to each photorealistic image \hat{x}ᵢ. The rendered image set X̅ and the input animation X are fed into a compute loss & update model module 306 to update the photorealistic image generation module 302 and the 3D representation model ψ 304. Then, the system goes into the next iteration t+1.

The initialization of the model parameters in the photorealistic image generation module 302 and the 3D representation model ψ 304 can vary, e.g., randomly initialized or set by pretrained values, or parts of the parameters being randomly initialized, and parts of the parameters are set by pretrained values. The compute loss & update model module 306 can also update parts of the parameters. After the T iterations, the learned 3D representation model ψ 304 is used in the test stage where, given a novel view v*, the 3D representation model ψ 304 computes a rendered novel image x̅* for the 3D scene consistent with the photorealistic image set \hat{X} corresponding to that novel view v* that may or may not be included in the training views V. In an embodiment, the rendered novel image x̅* comprises one or more photorealistic frames, novel content, novel camera views, and/or the same semantic content. As used herein, a novel view (or simply, a new view) is defined as a view for which there may or may not be a corresponding image available, a view for which an image may have not previously been generated or rendered, and/or a view which may not be directly obtained from the available view information. As used herein, a rendered novel image (or simply, a new image) is defined as an image that may have not previously been generated or rendered.

In an embodiment, side information S may be used by the overall framework 300. Side information may include, for example, a depth map. Optionally, when side information S is available, such as the depth maps s₁, . . . , sₙ, n≥1, where each sᵢ is the depth map of xᵢ, the side information S can be used by the photorealistic image generation module 302, the 3D representation model ψ 304, and the compute loss & update model module 306 to improve the system performance in training. The optional side information S is depicted as dotted lines in FIG. 3.

### Photorealistic Image Generation.

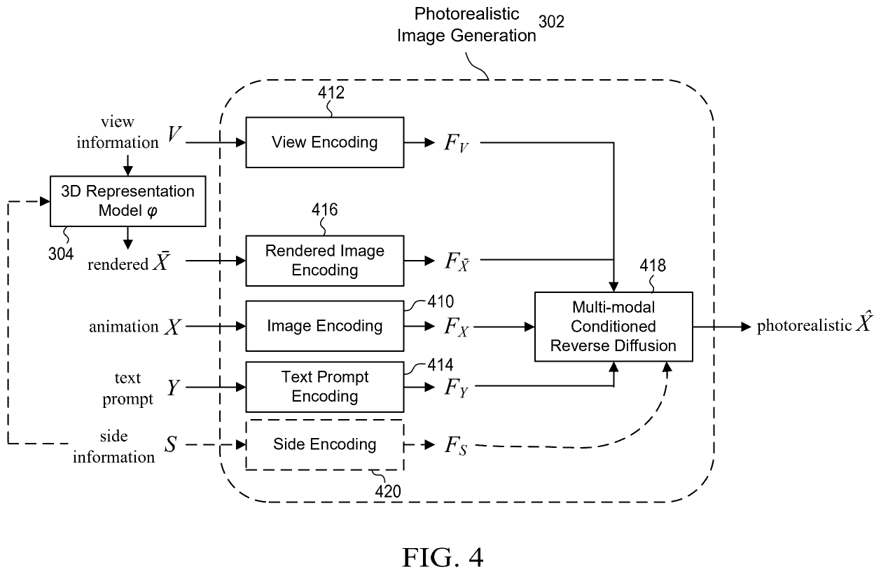

FIG. 4 is a schematic diagram of the photorealistic image generation module 302 according to an embodiment of the disclosure. FIG. 4 provides further details of a preferred embodiment of the photorealistic image generation module 302 of FIG. 3. Given the input animation X, an image encoding module 410 computes an image encoding feature F_{X}, comprising of n image encoding features fₓ_{₁}, . . . , fₓ_{ₙ}, where each fₓ_{ᵢ} corresponds to the input xᵢ. Given the view information V, a view encoding module 412 computes a view encoding feature F_{V}, comprising of n new encoding features fᵥ_{₁}, . . . , fᵥ_{ₙ} where each fᵥ_{ᵢ} corresponds to the input xᵢ. Given text prompt Y, a text prompt encoding module 414 computes a text encoding feature F_{Y}. Also, based on the view information V, the 3D representation model ψ 304 computes the rendered X̅, and a rendered image encoding module 416 computes a render image encoding feature F_{X̅}, comprising of n rendered image feature f_{x̅}_{₁}, . . . , f_{x̅}_{ₙ}, where each f_{x̅}_{ᵢ} corresponds to the rendered x̅ᵢ, which further corresponds to the input xᵢ. Optionally, give side information S, a side information encoding module 420 computes side information feature F_{S}. Then, a multi-modal conditional reverse diffusion module 418 computes the photorealistic images \hat{X} based on the image encoding feature F_{X}, the view encoding feature F_{V}, the text encoding feature F_{Y}, the render image encoding feature F_{X̅}, and optionally the side information feature F_{S}. In an embodiment, the multi-modal conditional reverse diffusion module 418 comprises a vision language model.

In an embodiment, the side information module 420 may be included in the photorealistic image generation module 302. The side information module 420 may utilize the side information S to improve the training or results of the multi-modal conditional reverse diffusion module 418 as depicted by the dotted line.

Various neural networks can be used as the image encoding module 410 and the rendered image encoding module 416, such as the visual transformer (ViT) like as detailed in document [13]. The image encoding module 410 and the rendered image encoding module 416 can have the same or different network structures. They can also have the same or different network parameters. Similarly, various networks can be used as the view encoding module 412, such as a multi-layer perceptron (MLP). Various networks can be used as the text prompt encoding module 414, such as the text embedding networks used in CLIP as detailed in document [6]. The present disclosure does not put any restrictions on the network structure of these modules and how these modules are obtained. In an embodiment, one or more of the image encoding module 410, the view encoding module 412, the text prompt encoding module 414, rendered image encoding module 416, and side information module 420 are implemented by a variational autoencoder (VAE) or a ViT.

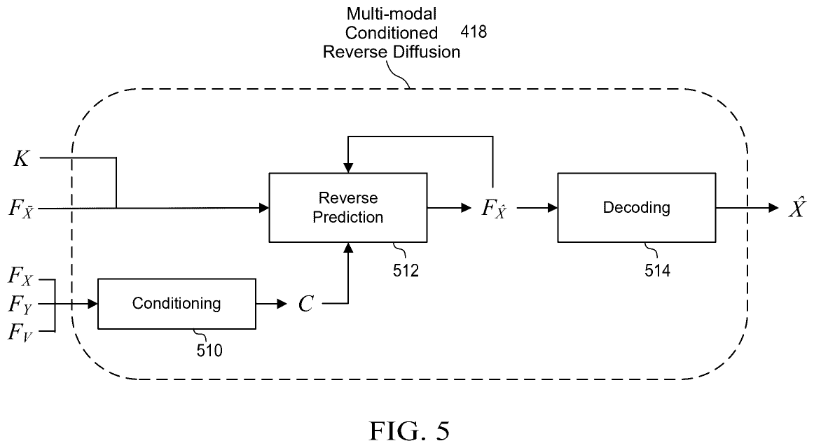

The multi-modal conditional reverse diffusion module 418 uses a conditional diffusion model for supplement detail generation. FIG. 5 is a schematic diagram of a multi-modal conditional reverse diffusion module 418 according to an embodiment of the disclosure. FIG. 5 provides further details of a preferred embodiment of the multi-modal conditional reverse diffusion module 418 of FIG. 4. Given as condition the image encoding feature F_{X}, the view encoding feature F_{V}, and the text encoding feature F_{Y}, and the render image encoding feature F_{X̅}, a conditioning module 510 first computes a diffusion condition C. The conditioning module 510 usually is a transformation network to first combine F_{X}, F_{V}, and F_{Y}, and then transform the combined result to the desired dimension (e.g., same as F_{X̅}). Then, a reverse prediction module 512 computes the reverse diffusion step p_{ϑ}(F_{\hat{X}}_{ₖ₋₁}|F_{\hat{X}}_{ₖ}, C), for example, by using a latent diffusion model (LDM) as detailed in document [14], where ϑ is the model parameters of the reverse prediction module 512. A total of K iterations are taken and k=1, . . . , K. K is used by the multi-model conditional reverse diffusion module 418. K can be pre-set, or can be determined for each input X. After K iterations, the final F_{\hat{X}}_{₀} is further processed by a decoding network 514 (e.g., the upsampling part of a U-Net, which is an encoder-decoder convolutional neural network) to generate the photorealistic \hat{X}.

In an embodiment, the reverse prediction module 512 can take the score-based diffusion models using ordinary differential equation (ODE) such as the method in as detailed in document [14], or the consistency diffusion models based on probability-flow ordinary differential equation (PF-ODE) such as the method in as detailed in document [15], or any other diffusion models as long as the model computes p_{ϑ}(F_{\hat{X}}_{ₖ₋₁}|F_{\hat{X}}_{ₖ}, C). The number of iterations K can vary between a single step to many steps, i.e., K≥1.

Note that in one embodiment, the photorealistic image generation module 302 is used to compute each f_{\hat{x}}_{ᵢ} through the reverse prediction module 512 based on each corresponding f_{x̅}_{ᵢ}, fᵥ_{ᵢ}, fₓ_{ᵢ}, f_{y}, and further generates \hat{x}ᵢ through the decoding network 514 (or simply, decoding module) corresponding to each individual input xᵢ. In another embodiment, the photorealistic image generation module 302 computes a set of x̅₁, . . . , \hat{x}ₘ, 1≤m≤n jointly, depending on different network structures of the photorealistic image generation module 302.

Note that in some embodiments, there can be multiple sets of multi-modal conditional reverse diffusion model 418 parameters in the photorealistic image generation module 302 process, one for each targeted specific type of content. Correspondingly, the input animated X, text prompt Y, rendered X̅, and side information S are separated into different parts to feed into these different sets of model parameters. For example, there can be a set of parameters for processing human faces, a set of parameters for processing grass and trees, a set of parameters for processing urban building structures, etc. In such case, the side information can contain additional information (e.g., segmentation maps) to indicate such semantic regions in animated X and rendered X̅.

Also, the text prompt Y can contain multiple instructions targeting at different types of content, e.g., transform cartoon faces into natural faces, transform cartoon grass to natural grass, keep other content unchanged as cartoon. Accordingly, the image encoding module 410, the rendered image encoding module 416, the text prompt encoding module 414, and the Side Encoding module 420 can be the same or different to compute the encoding features to feed into the different sets of multi-modal conditional reverse diffusion model parameters using the corresponding content-specific visual and text prompt inputs, such as the face image where other regions are masked out, and the text instruction only relate to faces.

In an embodiment, a training loss is determined based on a transformation loss and a realistic generation loss. To determine the transformation loss, one or more synthetic images X are used as input to obtain the photorealistic image set \hat{X}. In an embodiment, the transformation loss comprises a correspondence loss L_{c}(C_{X}, C_{\hat{X}}), where C_{X}, C_{\hat{X}} are domain invariant encoders pre-trained for synthetic data and realistic data respectively using contrastive learning, and a generative adversarial networks (GAN) loss L_{G}(D_{\hat{X}}), where D_{\hat{X}} is the probability of classifying \hat{X} as a realistic image by a discriminator. To determine the realistic generation loss, one or more real images X are used as input to obtain the photorealistic image set \hat{X}. In an embodiment, the realistic generation loss comprises a diffusion loss L_{d}(ε, ε_{θ}), where ε is random noise and ε_{θ} is estimated noise by diffusion model, and a semantic loss Lₛ(S_{X}, S_{\hat{X}}), where S_{X} and S_{\hat{X}} are top semantic labels from a pre-trained semantic image classifier. In an embodiment, the correspondence loss, the GAN loss, the diffusion loss, and the semantic loss are based on or take into account a distance metric (e.g., L1, L2, etc.).

### 3D Representation Model.

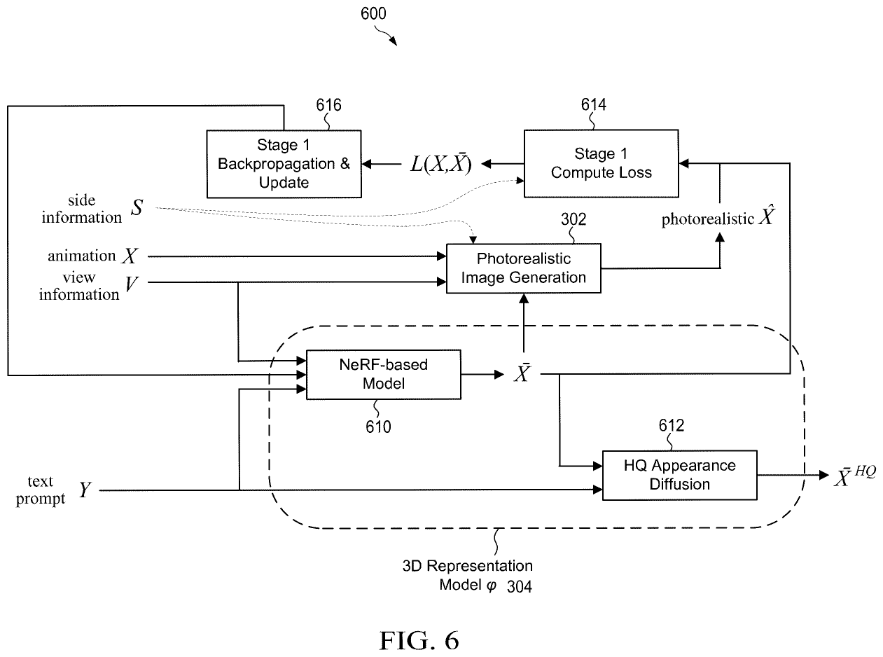

FIG. 6 is a schematic diagram of a first stage of a training process 600 of the 3D representation model ψ 304 according to an embodiment of the disclosure. In an embodiment, the 3D representation model ψ 304 has mainly two parts: a 3D-aware NeRF-based model 610 that models the 3D representation of the target scene, and a high-quality (HQ) appearance generation process 612 that generates HQ details. Accordingly, in an embodiment, the training process 600 of learning the 3D representation model ψ has two main stages. FIG. 6 illustrates the detailed workflow of the first stage of the training process 600. Specifically, given the input view information V, a NeRF-based model 610 first computes the rendered X̅. The NeRF-based model 600 (with parameters ψ_{NeRF}) is able to use any NeRF-based reflectance models, such as NeRF as detailed in document [10], MultiNeRF as detailed in document [16], or NeRV as detailed in document [17]. Then, the photorealistic image generation module 302 computes the photorealistic \hat{X} based on the rendered X̅, the text prompt Y, the view info V, and the animation X using the process as described in FIG. 4. The photorealistic \hat{X} and the rendered X̅ are used to compute a loss L(\hat{X},X̅) by a stage 1 compute loss module 614. The loss L(\hat{X},X̅) usually comprises several loss terms weighted and combined together. In some embodiments, the score distillation sampling (SDS) loss L_{SDS}(\hat{X},X̅) described in as detailed in document [11] is computed, where the parameters of the multi-modal conditional reverse diffusion model 418 are fixed. Overall, the multi-modal conditional reverse diffusion model 418 of FIG. 4 has a learned denoising process ξ_{τ}(F_{\hat{X}}_{ₖ}|F_{X̅}, k, C), which predicts the sampled noise ε given the rendered X̅ and the diffusion condition C by viewing the rendered X̅ as a noisy corrupted image degraded from the photorealistic \hat{X}. F_{\hat{X}}_{ₖ} is the latent feature corresponding to the k-th diffusion step, where F_{\hat{X}}_{_{K}}=F_{X̅}, and F_{X̅}_{₀}=F_{\hat{X}}. τ is the model parameters of the multi-modal conditional reverse diffusion model 418, which includes the parameters ϑ of the reverse prediction module 512 and all parameters in the conditioning module 510 described in FIG. 5. By using the multi-modal conditional reverse diffusion model 418 as a proxy score function, the gradient ∇_{ψ}_{_{NeRF}}L_{SDS}(\hat{X},X̅) can be computed as:

$${∇}_{{ψ}_{NeRF}} {L}_{SDS} ( \hat{X} , \overline{X} ) = {E}_{k , ε} [ {w}_{k} ( {ξ}_{τ} ( {F}_{{\hat{X}}_{k}} \vert {F}_{\overline{X}} , k , C ) - ε ) \partial \hat{X} / \partial {ψ}_{NeRF} ]$$

where wₖ is a weighting function depending on the diffusion step k. Other forms of loss, such as the variational score distillation sampling loss (VSDS) as described in as detailed in document [18] can also be used.

In addition, in an embodiment the photo-consistency loss L_{Con}(\hat{X},X̅) is also computed, which encourages the rendered images across different camera views to correspond to the same 3D photorealistic scene. For example, for each pair of rendered (x̅ᵢ,x̅ⱼ), with corresponding photorealistic (\hat{x}ᵢ, \hat{x}ⱼ) and animation (xᵢ,xⱼ), based on the corresponding views (vᵢ,vⱼ), the computed photorealistic \hat{x}ᵢ and \hat{x}ⱼ can be transformed to each other's views as \hat{x}_{i→j} and \hat{x}_{j→i}, and the distortion loss (e.g., combination of MSE between \hat{x}_{i→j} and \hat{x}ⱼ and MSE between \hat{x}_{j→i} and \hat{x}ᵢ) can be computed. Such distortion losses between various pairs are added up to obtain L_{con}(\hat{X},X̅). L_{con}(\hat{X},X̅) uses the detailed 3D information from the animated X to regularize the NeRF-based model so that finer geometry can be modeled by the NeRF-based model. Finally, various types of losses can be weighted combined to give the final L(\hat{X},X̅). Then, a stage 1 backpropagation & update module 616 computes the gradient of L(\hat{X},X̅) and backpropagates the gradient to update the model parameters of the NeRF-based model ψ_{NeRF}. The present disclosure does not put any restrictions on how model parameters are updated, such as the optimization methods, parameter initialization (e.g., finetuned from pretrained or randomly initialized), which parts are partially fixed, etc.

When side information S is optionally used (marked by dotted line), the side information may also be used by the stage 1 compute loss module 614, e.g., to weigh loss terms to focus on a particular depth region.

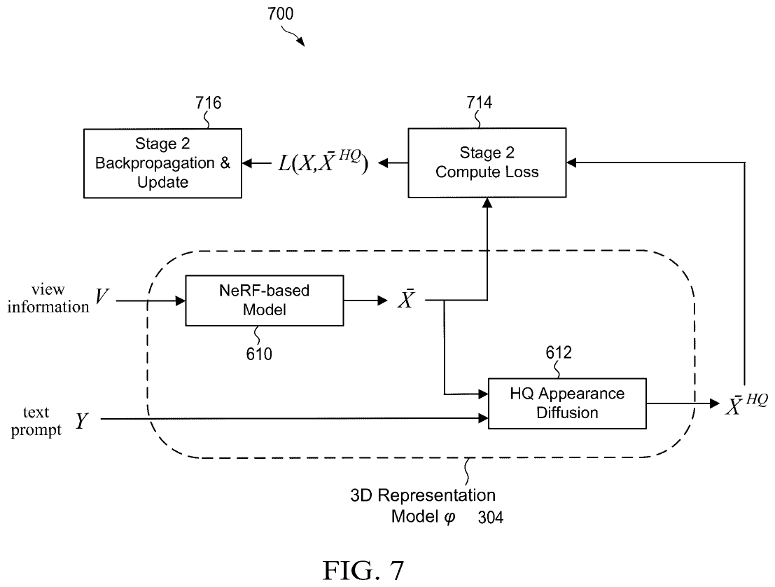

FIG. 7 is a schematic diagram of a second stage of a training process 700 of the 3D representation model according to an embodiment of the disclosure. In the second stage of the training process 700, the learned NeRF-based model 610 from training stage 1 is fine-tuned. Given the view information V comprising m view angles v₁, . . . , vₘ, the NeRF-based model 610 can directly compute the rendered X̅ comprising of m rendered images x₁, . . . , x, where each xᵢ corresponds to each vᵢ. Note that v₁, . . . , vₘ can be different from the view information V in training stage 1. Based on both the rendered X̅ and the text prompt Y, the HQ appearance diffusion module 612 uses a text-to-image diffusion network to compute an HQ rendered X̅^{HQ}. Various methods can be used by the HQ appearance diffusion module 612, such as the text-conditioned stable diffusion super resolution method described in Imagen as detailed in document [9]. Then, a stage 2 compute loss module 714 computes a HQ loss L (X̅,X̅^{HQ}) based on the rendered X̅ and the HQ rendered X̅^{HQ}. Specifically, let φ be the parameters of the HQ appearance diffusion module 612, which are fixed in this training process. In an embodiment, the score distillation sampling (SDS) loss L_{SDS}(X̅,X̅^{HQ}) described in document [11] is computed, where the HQ appearance diffusion module 612 comes with a learned denoising process

$${ξ}_{ϕ} ( {\overline{X}}_{j}^{HQ} , \vert Y , \overline{X} , j )$$

that predicts the sampled noise ε^{HQ} given the rendered X̅ and the text prompt Y, by viewing the rendered X̅ as a noisy corrupted image degraded from the HQ rendered

$${\overline{X}}^{HQ} . {\overline{X}}_{j}^{HQ}$$

is the sample corresponding to the j-th diffusion step, where

$${\overline{X}}_{K}^{HQ} = \overline{X} , and {\overline{X}}_{0}^{HQ} = {\overline{X}}^{HQ} .$$

By using the HQ appearance diffusion module as a proxy score function, the gradient ∇_{ψ}_{_{NeRFL}}L_{SDS}(X̅,X̅^{HQ}) can be computed as:

$${∇}_{{∇}_{{ψ}_{NeRF}}} {L}_{SDS} ( \overline{X} , {\overline{X}}^{HQ} ) = {E}_{j , {ε}^{HQ}} [ {w}_{j} ( {ξ}_{ϕ} ( {\overline{X}}_{j}^{HQ} , \vert Y , \overline{X} , j ) - {ε}^{HQ} ) \frac{\partial {\overline{X}}^{HQ}}{\partial {ψ}_{NeRF}} ]$$

where wⱼ is a weighting function depending on the diffusion step j. Other forms of loss, such as the Variational score distillation sampling loss (VSDS) as described in [18] can also be used. In some embodiments, the photo-consistency loss L_{Con}(X̅,X̅^{HQ}) can also be computed, which encourages that the rendered images across different camera views correspond to the same 3D photorealistic scene. All various types of loss can be weighted combined to give the final L(X̅,X̅^{HQ}). Then, a stage 2 backpropagation & update module 716 computes the gradient of L(X̅,X̅^{HQ}) and backpropagates the gradient to update the model parameters of the NeRF-based model ψ_{NeRF}. The present disclosure does not put any restrictions on how the model parameters are updated, such as the optimization methods, how model parameters are initialized (e.g., finetuned from pretrained model or randomly initialized), which parts of the model parameters are partially fixed and which parts are updated, etc.

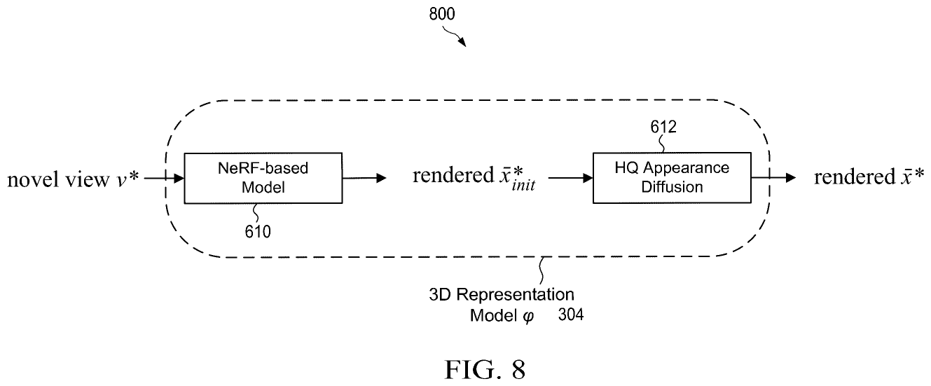

FIG. 8 is a schematic diagram of a final test stage of the 3D representation model 800 according to an embodiment of the disclosure. In the final test stage of the 3D representation model 800, the learned 3D representation model ψ is fixed. Given a novel view v*, the NeRF-based model 610 first computes an initial rendered x̅ᵢₙᵢₜ*, and then the HQ appearance diffusion module 612 computes a final rendered x* based on the initial rendered x̅ᵢₙᵢₜ*. x̅* is the virtual synthesized photorealistic frame generated for the 3D scene modelled by the learned 3D representation model ψ for the novel view angle v*, and the 3D scene is learned as the photorealistic scene defined by the animated input X and the text prompt Y in the training stage.

Note that in some embodiments, the HQ appearance diffusion process can be skipped and correspondingly the stage 2 of the training process can be skipped. In such cases, the initial rendered

$${\overline{x}}_{init}^{*}$$

will be used as the final rendered result, with a lower quality and lower resolution than the embodiments with the HQ appearance diffusion process.

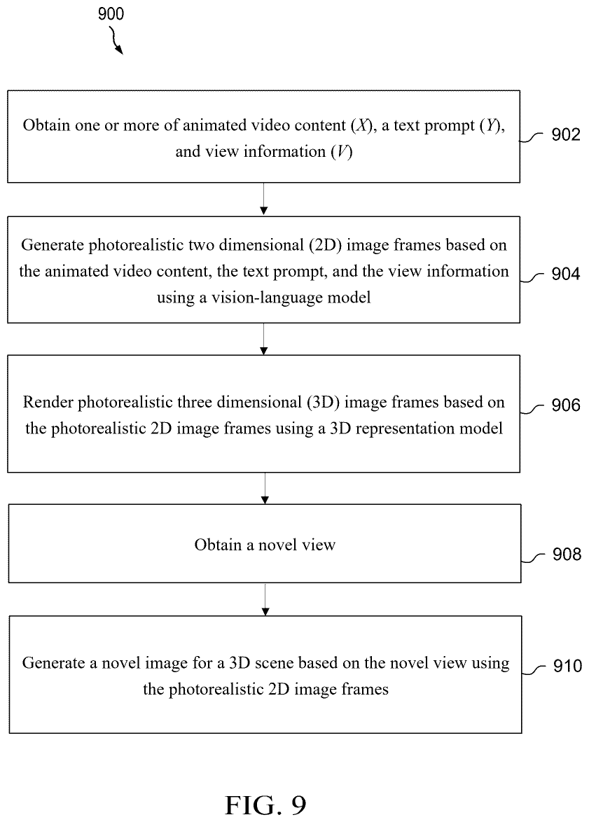

FIG. 9 is a method 900 implemented by a computing device according to an embodiment of the disclosure. In an embodiment, the computing device is a computer, a smart phone, a smart tablet, or other device configured to play games or display video content. In an embodiment, the method 900 is implemented during gaming or when video content is being consumed by a user.

In block 902, the computing device obtains one or more of animated video content (X), a text prompt (Y), and view information (V). In an embodiment, the animated video content comprises animated 2D video frames. In an embodiment, the animated video content comprises animated 3D video frames.

In an embodiment, the text prompt specifies which portion of an animated image is to be rendered as photorealistic. In an embodiment, the text prompt specifies how an animated image is to be edited to generate one of the photorealistic 3D image frames. In an embodiment, the text prompt is preset or predefined. In an embodiment, side information is obtained and used to compute the photorealistic 2D image frames.

In block 904, the computing device generates photorealistic 2D image frames (\hat{X}) based on the animated video content, the text prompt, and the view information using a vision-language model. In an embodiment, the photorealistic 2D image frames are generated by a photorealistic image generation module.

In block 906, the computing device renders photorealistic 3D image frames (X̅) based on the photorealistic 2D image frames using a 3D representation model. In an embodiment, the 3D representation model comprises a neural radiance fields (NeRF) diffusion model or a 3D-aware NeRF diffusion model. In an embodiment, method is iterated a number of times (t) to train the 3D representation model.

In block 908, the computing device obtains a novel view (v*). The novel view may be obtained from a user of the computing device, from the computing device, from an outside source, etc. In block 910, the computing device generates a novel image (x̅*) for a 3D scene based on the novel view using the photorealistic 2D image frames.

### Novelty and Advantages.

The proposed framework has the following novel features comparing to prior arts:

a. Better controlled photorealistic 3D content generation by using animated content as visual examples to provide visual controlling conditions in a cascaded diffusion model (CDM).

b. Improved quality of photorealistic 3D content generation by using text-guided animation-to-photorealistic image-to-image transformation. Comparing with direct text-to-3D generation, text-guided image-to-image transformation serves as robust proxy to provide finer geometry details to the learned 3D representation. As a result, the method can be applied to arbitrary objects and scenes.

c. Improved quality and resolution of photorealistic 3D content generation, by using separated NeRF-based model for 3D representation learning and HQ appearance diffusion for visual quality improvement. The separated steps provide stability and flexibility of using multiple pretrained stable diffusion models to help with different aspects of image generation. The text-guided image-to-image diffusion helps with geometry-aware animation-to-photorealistic 3D representation learning, and the HQ appearance diffusion focuses on improving qualities (resolutions, visual details, etc.) of the rendered result.

The following references are cited herein:
[1] T. Karras, S. Laine, and T. Aila. A style-based generator architecture for generative adversarial networks. CVPR 2019.
[2] P. Dhariwal and A. Nichol. Diffusion models beat gans on image synthesis. NeurIPS, 2021.
[3] H. Chang, H. Zhang, L. Jiang, C. Liu and W. T. Freeman. Maskgit: Masked generative image transformer. arXiv preprint arXiv:2202.04200, 2022.
[4] A. Ramesh, P. Dhariwal, A. Nichol, C. Chu, and M. Chen. Hierarchical text-conditioned image generation with clip latents. arXiv preprint: arXiv:2204.06125, 2022.
[5] L. Zhang and M. Agrawala. Adding conditional control to text-to-image diffusion models. arXiv preprint: arXiv 2302.05543, 2023.
[6] A. Radford, et al. Learning transferable visual models from natural language supervision. ar Xiv preprint, arXiv:2103.00020, 2021.
[7] J. Li and et al. BLIP-2: Bootstrapping language-image pre-training with frozen image encoders and large language models. arXiv preprint. arXiv:2301.12597.
[8] A. Jain and et al. Zero-shot text-guided object generation with dream fields. CVPR 2022.
[9] C. Saharia, et al. Photorealistic text-to-image diffusion models with deep language understanding, arXiv preprint, arXiv: 2205.11487, 2022.
[10] B. Mildenhall and et al. NeRF: Representing scenes are neural radiance fields for view synthesis. ECCV 2020.
[11] B. Poole and et al. Dreamfusion: Text-to-3d using 2d diffusion. arXiv preprint, arXiv:2204.06125, 2022.
[12] C. Lin and et al. Magic3D: High-resolution text-to-3D content creation. arXiv preprint, arXiv:2211.104402, 2023.
[13] A. Dosovitskiy and et al. An image is worth 16×16 words: Transformers for image recognition at scale. ICLR, 2021
[14] R. Rombach, et al. High-resolution image synthesis with latent diffusion models. CVPR 2022.
[15] Y. song and et al. Consistency models. arXiv preprint. arXiv:2303.01469, 2023
[16] B. Mildenhall and et al. MultiNeRF: A code release for mip-NeRF 360, Ref-NeRF, and RawNeRF. URL: https://github.com/google-research/multinerf
[17] P. Srinivasan and et al. NeRV: Neural reflectance and visibility fields for relighting and view synthesis. CVPR 2021
[18] Z. Wang and et al. ProlificDreamer: High-fidelity and diverse text-to-3D generation with variational score distillation. arXiv preprint. arXiv:2305.16213.

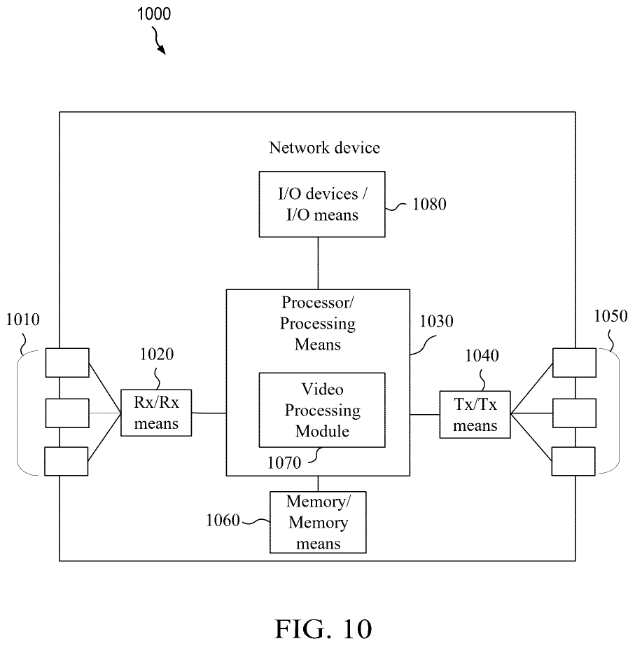

FIG. 10 is a schematic diagram of a computing device 1000 (e.g., a personal computer, smart phone, smart tablet, handheld gaming device, etc.) according to an embodiment of the disclosure. The computing device 1000 is suitable for implementing the disclosed embodiments as described herein. The computing device 1000 comprises ingress ports/ingress means 1010 (a.k.a., upstream ports) and receiver units (Rx)/receiving means 1020 for receiving data; a processor, logic unit, or central processing unit (CPU)/processing means 1030 to process the data; transmitter units (Tx)/transmitting means 1040 and egress ports/egress means 1050 (a.k.a., downstream ports) for transmitting the data; and a memory/memory means 1060 for storing the data. The computing device 1000 may also comprise optical-to-electrical (OE) components and electrical-to-optical (EO) components coupled to the ingress ports/ingress means 1010, the receiver units/receiving means 1020, the transmitter units/transmitting means 1040, and the egress ports/egress means 1050 for egress or ingress of optical or electrical signals.

The processor/processing means 1030 is implemented by hardware and software. The processor/processing means 1030 may be implemented as one or more CPU chips, cores (e.g., as a multi-core processor), field-programmable gate arrays (FPGAs), application specific integrated circuits (ASICs), and digital signal processors (DSPs). The processor/processing means 1030 is in communication with the ingress ports/ingress means 1010, receiver units/receiving means 1020, transmitter units/transmitting means 1040, egress ports/egress means 1050, and memory/memory means 1060. The processor/processing means 1030 comprises a video processing module 1070 (or an image processing module). The video processing module 1070 is able to implement the methods disclosed herein. The inclusion of the video processing module 1070 therefore provides a substantial improvement to the functionality of the computing device 1000 and effects a transformation of the computing device 1000 to a different state. Alternatively, the video processing module 1070 is implemented as instructions stored in the memory/memory means 1060 and executed by the processor/processing means 1030.

The computing device 1000 may also include input and/or output (I/O) devices or I/O means 1080 for communicating data to and from a user. The I/O devices or I/O means 1080 may include output devices such as a display for displaying video data, speakers for outputting audio data, etc. The I/O devices or I/O means 1080 may also include input devices, such as a keyboard, mouse, trackball, etc., and/or corresponding interfaces for interacting with such output devices.

The memory/memory means 1060 comprises one or more disks, tape drives, and solid-state drives and may be used as an over-flow data storage device, to store programs when such programs are selected for execution, and to store instructions and data that are read during program execution. The memory/memory means 1060 may be volatile and/or non-volatile and may be read-only memory (ROM), random access memory (RAM), ternary content-addressable memory (TCAM), and/or static random-access memory (SRAM).

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by a computing device, comprising:
obtaining one or more of animated video content (X), a text prompt (Y), and view information (V);
generating photorealistic two dimensional (2D) image frames (\hat{X}) based on the animated video content, the text prompt, and the view information using a vision-language model;
rendering photorealistic three dimensional (3D) image frames (X̅) based on the photorealistic 2D image frames using a 3D representation model;
obtaining a novel view (v*); and
generating a novel image (x̅*) for a 3D scene based on the novel view using the photorealistic 2D image frames.

2. The method of claim 1, wherein the obtaining the one or more of the animated video content, the text prompt, and the view information, the generating photorealistic 2D image frames, and the rendering photorealistic 3D image frames (X̅) is iterated a number of times (t) to train the 3D representation model.

3. The method of claim 1, wherein the 3D image frames comprise 2D image frames and the view information associated with the 2D image frames.

4. The method of claim 1, wherein the text prompt specifies how an animated image is to be edited to generate one of the photorealistic 3D image frames.

5. The method of claim 1, further comprising obtaining side information, and computing the photorealistic 2D image frames based on the side information.

6. The method of claim 1, wherein the 3D representation model comprises a neural radiance fields (NeRF) diffusion model or a 3D-aware NeRF diffusion model.

7. The method of claim 1, wherein the animated content comprises a set of animated images represented as images x₁, . . . xₙ, wherein the view information is represented as views v₁, . . . vₙ, wherein n is greater than or equal to 1, and wherein each view vᵢ provides view-related information for each image xᵢ.

8. The method of claim 7, wherein the view-related information comprises one or more of a view angle and a camera intrinsic parameter.

9. The method of claim 7, wherein an image xᵢ is associated with a depth map.

10. The method of claim 1, further comprising sequentially displaying the photorealistic 3D image frames on a display to produce 3D video content.

11. The method of claim 1, wherein generation of the 2D image frames comprises computing one or more of the following:
an image encoding feature (F_{X}) based on the animated video content;
a text encoding feature (F_{Y}) based on the text prompt;
a view encoding feature (F_{V}) based on the view information; and
a render image encoding feature (F_{X̅}) based on one of the photorealistic 3D image frames.

12. The method of claim 11, wherein generation of the 2D image frames comprises computing a side information feature (F_{S}).

13. The method of claim 12, further comprising generating the photorealistic 2D image frames based on one or more of the image encoding feature, the text encoding feature, the view encoding feature, the render encoding feature, and the side information feature.

14. The method of claim 1, wherein the vision-language model comprises a multi-modal conditioned reverse diffusion module, wherein the multi-modal conditioned reverse diffusion module comprises a conditioning module that computes a diffusion condition (C) based on one or more of the image encoding feature, the view encoding feature, and the text encoding feature, wherein the multi-modal conditioned reverse diffusion module comprises a reverse prediction module that computes a reverse diffusion step p_{ϑ}(F_{\hat{X}}_{ₖ₋₁}|F_{\hat{X}}_{ₖ}, C), where ϑ represents model parameters of the reverse prediction module, k represents a number of iterations, and C represents the diffusion condition, and wherein the multi-modal conditioned reverse diffusion module comprises a decoding network that computes one or more of the photorealistic 3D image frames based on the reversion diffusion step.

15. The method of claim 1, wherein the 3D representation model is trained in a first stage when:
a neural radiance fields (NeRF)-based model computes the photorealistic 3D image frames;
a photorealistic image generation module computes the photorealistic 2D image frames based on the one or more of the photorealistic 3D image frames, the text prompt, the view information, and the animated video content;
a first stage compute loss module computes a first stage compute loss based on the photorealistic 3D image frames and the photorealistic 2D image frames; and
a first stage backpropagation and update module computes a first stage gradient of the photorealistic 3D image frames and the photorealistic 2D image frames based on the first stage compute loss and backpropagates the first stage gradient to update model parameters of the NeRF-based model.

16. The method of claim 15, wherein the 3D representation model is trained in a second stage when:
the NeRF-based model computes the photorealistic 3D image frames, wherein each of the photorealistic 3D image frames corresponds to each view;
a high-quality (HQ) appearance diffusion module uses a text-to-image diffusion network to compute HQ photorealistic 3D image frames based on the photorealistic 3D image frames and the text prompt;
a second stage compute loss module computes a second stage compute loss based on the HQ photorealistic 3D image frames and the photorealistic 3D image frames; and
a second stage backpropagation and update module computes a second stage gradient of the photorealistic 3D image frames and the HQ photorealistic 3D image frames based on the second stage compute loss and backpropagates the second stage gradient to update model parameters of the NeRF-based model.

17. The method of claim 16, wherein one or more of the photorealistic image generation module, first stage compute loss module, and first stage backpropagation and update module receive and use side information.

18. The method of claim 17, further comprising finally testing the 3D representation model by:
computing an initial rendered image (\hat{x}ᵢₙᵢₜ*) based on the novel view (v*) using the NeRF-based model; and
computing a final rendered 3D image frame (X̅*) based on the initial rendered image using the HQ appearance diffusion module.

19. A computing device, comprising:
a memory storing instructions; and
one or more processors coupled to the memory, the one or more processors configured to execute the instructions to cause the computing device to:
obtain one or more of animated video content (X), a text prompt (Y), and view information (V);
generate photorealistic two dimensional (2D) image frames (\hat{X}) based on the animated video content, the text prompt, and the view information using a vision-language model;
render photorealistic three dimensional (3D) image frames (X̅) based on the photorealistic 2D image frames using a 3D representation model;
obtain a novel view (v*); and
generate a novel image (x̅*) for a 3D scene based on the novel view using the photorealistic 2D image frames.

20. A non-transitory computer readable medium comprising a computer program product for use by a computing device, the computer program product comprising computer executable instructions stored on the non-transitory computer readable medium that, when executed by one or more processors, cause the ingress network node to:
obtain one or more of animated video content (X), a text prompt (Y), and view information (V);
generate photorealistic two dimensional (2D) image frames (\hat{X}) based on the animated video content, the text prompt, and the view information using a vision-language model;
render photorealistic three dimensional (3D) image frames (X̅) based on the photorealistic 2D image frames using a 3D representation model;
obtain a novel view (v*); and
generate a novel image (x̅*) for a 3D scene based on the novel view using the photorealistic 2D image frames.
